(19) United States
(12) Patent Application Publication
(10) Pub. No.: US 2005/0211105 A1
(43) Pub. Date: Sep. 29, 2005

(54) Coated metal cookware

(76) Inventor: Michael T. P. Hanson, Monroe, NC (US)

Correspondence Address: DOUGHERTY, CLEMENTS, HOFER, BERNARD & WALKER, 1901 ROXBOROUGH ROAD, SUITE 300, CHARLOTTE, NC, 28211, US

(21) Appl. No.: 10/808,972

(22) Filed: Mar. 25, 2004

(51) Int. Cl. A47J 37/10

(52) U.S. Cl. 99/422

(57) ABSTRACT

Electroless-nickel-plated metal cookware, having a substrate consisting of a skillet, pot, pan or the like, coated by cleaning and deoxidizing the surface of the cookware substrate, rinsing the substrate, and applying an electroless nickel coating to the surface of the metal substrate. The method of coating is also disclosed.

### FIELD OF THE INVENTION

The present invention relates generally to cookware, and more particularly to items of cookware having an electroless nickel outer layer, and to a method of coating such cookware.

### BACKGROUND OF THE INVENTION

Cookware, particularly pans such as frying pans, pots, and the like are typically made of cast iron, steel, aluminum, copper, brass, or copper alloy.

Various coatings, treatment processes and metals have been used to improve the wearability and durability of cookware. However, after a period of use, the coatings tend to wear off or become eroded during the scrubbing and cleaning process or become corroded. Consumers typically have no means for avoiding such wear. As a result, worn or corroded cookwear is not used or it is discarded.

Cast iron, which is used for frying pans, is porous to a small degree. It retains minute particles from a previous item which was cooked in it. Thus, when cast iron is used for frying fish, then cleaned and used to make gravy, the gravy may develop a fish taste, which is objectionable.

Thus, there is a need for cookwear that provides an extended period of use without becoming corroded, and that does not lose metallic particles or oxides to the food being prepared. There is also a need for a non-stick pan that has the ability to cause food not to stick to the cooking surface during the entire lifetime of the pan.

### DESCRIPTION OF THE PRIOR ART

Applicant is aware of the following U.S. patents concerning electroless nickel coating of a substrate:

| U.S. | | | |
|---|---|---|---|
| Pat. No. | Issue Date | Inventor | Title |
| 2,532,283 | Dec. 5, 1950 | Brenner et al. | NICKEL PLATING BY |
| | | | CHEMICAL REDUCTION |
| 2,685,839 | Nov. 10, 1953 | Talmey et al. | PROCESS OF CHEMICAL |
| | | | NICKEL PLATING |
| 2,999,770 | Sep. 12, 1961 | Gutzeit | PROCESSES OF |
| | | | CHEMICAL NICKEL |
| | | | PLATING AND |
| | | | BATHS THEREFOR |
| 4,321,285 | Mar. 23, 1982 | Feldstein | ELECTROLESS PLATING |

### SUMMARY OF THE INVENTION

The invention provides an electroless-nickel-plated surface on metal cookware, particularly on skillets and pots and pans. A substrate consisting of a skillet, griddle, pot, pan, grill or cooking grate (which terms are used interchangeably herein) to be coated is treated by cleaning and deoxidizing the surface of the substrate, rinsing the substrate, and applying an electroless nickel coating to the surface of the metal substrate.

### OBJECTS OF THE INVENTION

The principal object of the present invention is to provide a coated skillet, pot, pan, grill, griddle, or other metal cookware.

Another object of the invention is to provide a metal cookware item having a coating that inhibits oxidation of the surface thereof.

A further object of this invention is to provide a method for producing an electroless nickel coated skillet, pot, pan, or other cookware.

Another object of the invention is to provide a coated item of cookware, which is resistant to food sticking to the surface thereof, and which retains its lubricity for its entire lifetime of use.

Another object of the invention is to provide a tough, durable, long lasting, item of cookwear, which is resistant to corrosion.

Another object of the invention is to provide cookware which does not retain any indication of an item previously cooked therein.

### BRIEF DESCRIPTION OF THE DRAWINGS

The foregoing and other objects will become more readily apparent by referring to the following detailed description and the appended drawing in which:

FIG. 1 is a diagram of the method of electroless nickel plating of cookware according to the invention.

FIG. 2 is a cross-sectional diagram of an electroless nickel plating tank with an immersion rack.

FIG. 3 is a cross-sectional diagram of an alternative embodiment of an electroless nickel plating tank and associated immersion apparatus.

### DETAILED DESCRIPTION

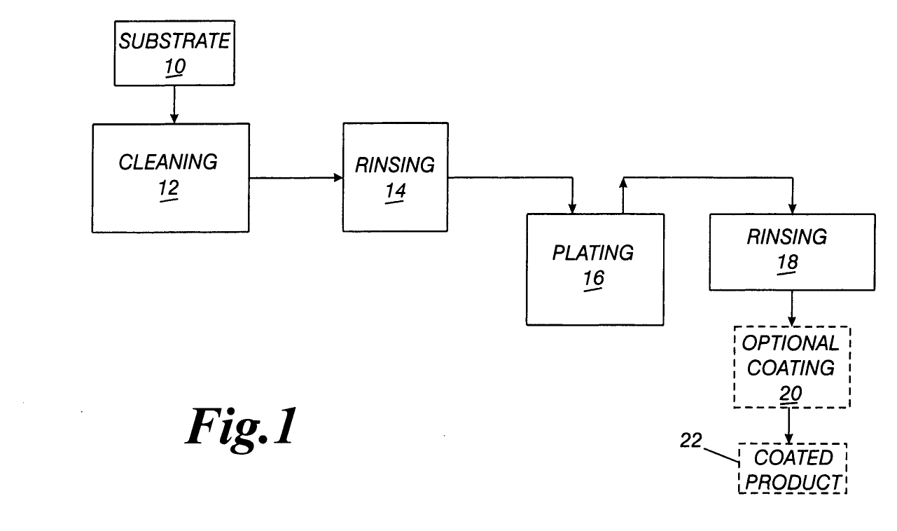

Referring now to the invented method as illustrated in FIG. 1, a metal cookware substrate 10 is provided, which undergoes a cleaning step 12, followed by a rinsing step 14. The substrate is moved to and undergoes a plating step 16, which is followed by another rinsing step 18. An optional coating step 20 may be used to apply a stain resistant coating to the surface of the cookware. The product of the method depicted is an item of coated nickel cookware 22.

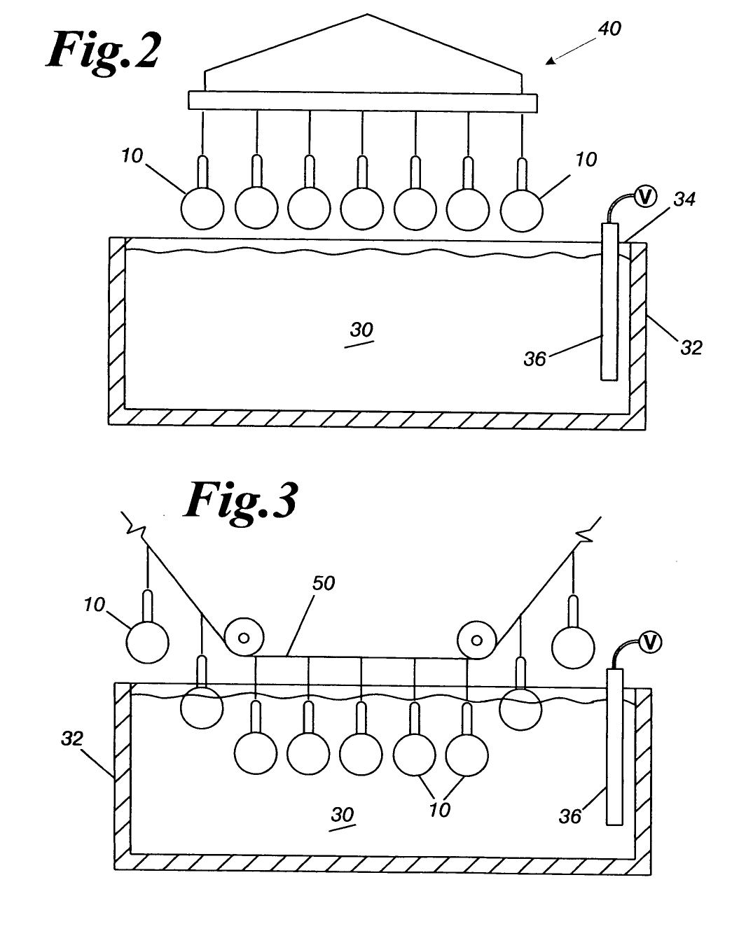

A nickel plating bath is shown in FIG. 2, into which an electroless plating solution 30 is supplied in sufficient quantity to fill a plating tank 32 to within a few inches of the top 34 of the tank, and is heated by any suitable means, such as an immersion heater 36, a heating jacket surrounding the tank, or an induction heater. If the immersion heater is electric, as shown, it is connected to a source of electricity V.

Prior to plating, the surface to be plated or coated is selectively cleaned and prepared to accept the nickel coating in step 12. This step includes one or more of grinding, cleaning, polishing, blasting, and etching procedures. Preferably, the iron or other metal pan is cleaned with a blast of glass beads, at a high pressure, usually about 70 psi.

After cleaning, the substrate is rinsed. Air is blown against the substrate to remove particulate material remaining thereon, followed by a blast of clean, filtered water to clean off the remaining residue.

The cookware is inserted into the plating bath for a period of time sufficient to attain a coating of from not less than 0.0003 inch to no more than 0.0025 inch, during which air sparging of the bath is conducted to cause circulation of the bath and complete coverage of the substrate by the nickel containing coating. For a coating thickness in the optimum range, the substrate should remain in contact with the coating material for about 1½ to 2 hours.

The cookware substrates 10 may be suspended from a rack 40 into the plating solution 30 as shown in FIG. 2, or they may be attached to a moving wire 50, as shown in FIG. 3, which dips downward to place the substrates into the plating solution, removing the substrates after they have been in the plating bath for a sufficient period of time. Immersion of the cookware substrates into the plating solution may be accomplished by any other convenient means.

The electroless nickel layer may be applied in a single bath or a series of baths, with the electroless nickel being in a solution of nickel sulfate (NiSO₄) and hypophosphate. The conventional method of identifying electroless nickel is by the phosphorus content, (e.g., low phosphorus 2-5%; medium phosphorus 6-9%; and high phosphorus 10-14%). The preferred phosphorus content of the electroless nickel layer in the present invention is no greater than the upper limit of high phosphorous content of 14%, but more preferably the phosphorus content is in the medium range, with a weight percent of phosphorus of about 6% to about 9% of the coating as deposited on the substrate.

The plated cookware is rinsed with clean water at least once, preferably twice, to remove excess nickel. The plated cookware is then placed in filtered water at a temperature in excess of 110° F., preferably about 125° F., to raise the temperature of the cookware. This is followed by blowing with air, which causes the water to evaporate rapidly because of the high temperature of the cookware.

Optionally, a stain resistant coating, such as vegetable oil, may be applied to the surface of the substrate in optional coating step 20.

The nickel in the plating solution is an FDA approved lead-free, cadmium-free solution, formulated and blended to contain no less than 8% nickel and no more than 14% phosphorus. Lead is usually added to a plating solution as a stabilizer, while cadmium is normally added as a brightener. The invented process employs neither lead nor cadmium, which results in a coating which is free of both lead and cadmium.

The nickel from the plating solution is applied to the substrate surface at a thickness no less than 0.0003 inch and no more than 0.0025 inch.

The nickel is applied uniformly over the entire surface, sealing the substrate (which can be cast iron, aluminum, copper, brass, or steel) from the atmosphere, insuring total coverage and adhesion.

The nickel coating will pass an ASTM (American Society of Testing Materials) nitric acid test and an ASTM B117 salt spray test, and will achieve a minimum hardness of 58 on the Rockwell C scale. The nickel coating will meet military specification standard Mil-C-26074E.

The nickel plating solution is an aqueous solution which can include a composite of phosphorus, boron, diamond, silicon, nitrate, or any such desired bath or composite.

The composition of the electroless nickel-plating bath may be any suitable composition which will result in the desired coating, for example, any of the compositions set forth in Table 1, Page 741, Vol. 8 of “Encyclopedia of Chemical Technology”, Third Edition, Dan Wiley & Sons, N.Y., 1979, which are also set forth in abstract format in the Table in U.S. Pat. No. 2,532,283 and 2,999,770. A nickel-phosphorus coating has an amorphic structure with a natural lubricity.

The method of making an item of coated metal cookware basically comprises the steps of: a) providing a substrate consisting or a pot, pan or other cookware to be coated; b) cleaning or deoxidizing the surface of the substrate to be coated; and c) applying an electroless nickel coating to the surface of the metal substrate.

### SUMMARY OF THE ACHIEVEMENT OF THE OBJECTS OF THE INVENTION

From the foregoing, it is readily apparent that I have invented an improved non-stick coated skillet, pot, pan, or other metal cookware, which is durable and resistant to corrosion, and which has a coating that inhibits oxidation of the surface thereof, and is resistant to food sticking to the surface thereof, as well as providing a method for producing an electroless nickel coated skillet, pot, pan, or other cookware.

It is to be understood that the foregoing description and specific embodiments are merely illustrative of the best mode of the invention and the principles thereof, and that various modifications and additions may be made to the apparatus and method by those skilled in the art, without departing from the spirit and scope of this invention, which is therefore understood to be limited only by the scope of the appended claims.

1. A coated metal cookware article, comprising:
a substrate made of metal selected from the group consisting of iron, steel, aluminum, copper, brass, and alloys thereof; and
an electroless nickel coating thereon.

2. A coated metal cookware article according to claim 1, whereon said coating has a thickness not less than 0.0003 inch.

3. A coated metal cookware article according to claim 1, whereon said coating has a thickness no greater than 0.0025 inch.

4. A coated metal cookware article according to claim 1, whereon said coating has a nickel content no less than 8 percent.

5. A coated metal cookware article according to claim 1, whereon said coating has a phosphorus content no greater than 14%.

6. A coated metal cookware article according to claim 1, whereon said coating is free of cadmium and lead.

7. A coated metal cookware article according to claim 1, whereon said substrate is cast iron.

8. A coated metal cookware article according to claim 1, wherein said substrate is selected from the group consisting of a pot, pan, skillet, griddle, grill, or cooking grate.

9. A method of making an item of coated metal cookware, comprising the steps of:
a) providing a substrate consisting of a pot, pan, skillet, griddle, grill, or cooking grate to be coated;
b) cleaning or deoxidizing the surface of the substrate to be coated; and
c) applying an electroless nickel coating to the surface of the metal substrate.

10. A method according to claim 9, wherein the cleaning step comprises one or more of the steps of grinding, cleaning, polishing, blasting, and etching the surface of the substrate to be coated.

11. A method according to claim 9 wherein the cleaning step comprises blasting of the substrate with glass beads.
